(19) United States
(12) Patent Application Publication
(10) Pub. No.: US 2013/0201915 A1
(43) Pub. Date: Aug. 8, 2013

(54) APPARATUSES AND METHODS FOR OUT-OF-BAND INFORMATION FEEDBACK

(71) Applicant: HTC CORPORATION, Taoyuan City (TW)

(72) Inventor: Huaiyuan WANG, Bellevue, WA (US)

(73) Assignee: HTC CORPORATION, Taoyuan City (TW)

(21) Appl. No.: 13/749,395

(22) Filed: Jan. 24, 2013

Related U.S. Application Data
(60) Provisional application No. 61/595,762, filed on Feb. 7, 2012.

(51) Int. Cl. H04W 24/10; H04W 4/00

(52) U.S. Cl. CPC H04W 24/10; H04W 4/005
USPC 370/328

(57) ABSTRACT

A hybrid receiver is provided with a first wireless communication module and a second wireless communication module. The first wireless communication module is configured to establish a first connection with a hybrid transmitter using a first wireless technology, and generate reception status information of the first connection. The second wireless communication module is configured to report the reception status information to the hybrid transmitter using a second wireless technology.

### CROSS REFERENCE TO RELATED APPLICATIONS

This Application claims priority of U.S. Provisional Application No. 61/595,762, filed on Feb. 7, 2012, and the entirety of which is incorporated by reference herein.

### BACKGROUND OF THE INVENTION

1. Field of the Invention

The invention generally relates to information feedback in the field of wireless communications, and more particularly, to apparatuses and methods for out-of-band information feedback between a hybrid receiver and a hybrid transmitter.

2. Description of the Related Art

With demand growing for ubiquitous computing and networking, various wireless technologies have been developed, including the Wireless Local Area Network (WLAN) technologies, such as the Wireless Fidelity (WiFi) technology, Bluetooth technology, Near Field Communication (NFC) technology, and ZigBee technology, etc., and the cellular network technologies (or called Wireless Wide Area Network (WWAN) technologies), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, Time-Division LTE (TD-LTE) technology, and others.

For user convenience and flexibility, most communication devices nowadays are equipped with more than one wireless communication module for supporting different wireless technologies. These communication devices are also referred to as hybrid transmitters or hybrid receivers, depending on whether their operations are primarily in transmission or reception states. Taking a smart phone supporting multiple wireless technologies as an example, a WCDMA module therein is responsible for providing WWAN communication services using the WCDMA technology, while a WiFi module and a Bluetooth module therein are responsible for providing WLAN and WPAN (Wireless Personal Area Network) communication services using WiFi and Bluetooth technologies, respectively. However, the operations associated with each of the wireless communication modules for providing communication services are carried out independently on different radio interfaces.

### BRIEF SUMMARY OF THE INVENTION

In a first aspect of the invention, a hybrid receiver is provided. The hybrid receiver comprises a first wireless communication module and a second wireless communication module. The first wireless communication module is configured to establish a first connection with a hybrid transmitter using a first wireless technology, and continuously collects reception status information of the first connection. Such reception status information includes (but not limited to) Channel Quality Indication (CQI), Signal-to-Noise Ratio (SNR), Packet Loss Rate (PLR), Packet Error Rate (PER), and receiving buffer status. The second wireless communication module is configured to report the reception status information to the hybrid transmitter using a second wireless technology.

In a second aspect of the invention, an information feedback method for a hybrid receiver supporting a first wireless technology and a second wireless technology is provided. The information feedback method comprises the steps of: establishing a first connection with a hybrid transmitter using the first wireless technology; generating reception status information of the first connection; and reporting the reception status information to the hybrid transmitter using the second wireless technology.

In a third aspect of the invention, a hybrid transmitter is provided. The hybrid transmitter comprises a first wireless communication module and a second wireless communication module. The first wireless communication module is configured to establish a first connection with a hybrid receiver using a first wireless technology. The second wireless communication module is configured to receive reception status information of the first connection from the hybrid receiver using a second wireless technology, so that the first wireless communication module adjusts at least one configuration associated with the first connection according to the reception status information.

In a fourth aspect of the invention, an information feedback method for a hybrid transmitter supporting a first wireless technology and a second wireless technology is provided. The information feedback method comprises the steps of: establishing a first connection with a hybrid receiver using the first wireless technology; receiving reception status information of the first connection from the hybrid receiver using the second wireless technology; and adjusting at least one configuration associated with the first connection according to the reception status information.

Other aspects and features of the present invention will become apparent to those with ordinarily skill in the art upon review of the following descriptions of specific embodiments of the hybrid receivers, hybrid transmitters, and the information feedback methods.

### BRIEF DESCRIPTION OF DRAWINGS

The invention can be more fully understood by reading the subsequent detailed description and examples with references made to the accompanying drawings, wherein:

FIG. 1 is a block diagram of a wireless communication environment according to an embodiment of the invention;

FIG. 2 is a block diagram illustrating an exemplary system architecture for the hybrid transmitter 10 and the hybrid receiver 20 according to an embodiment of the invention;

FIGS. 3A and 3B are message sequence charts illustrating the information feedback via the Bluetooth Low Energy (BLE) Data Channel Connection with respect to the embodiment of FIG. 2;

FIG. 4 is a schematic diagram illustrating the operations of the BLE basebands in the BLE Connection state according to an embodiment of the invention;

FIGS. 5A and 5B are message sequence charts illustrating the information feedback via the BLE Directed Advertisement with respect to the embodiment of FIG. 2;

FIG. 6 is a block diagram illustrating a wireless communication environment for information feedback using the BLE technology during video streaming via a WiFi connection according to an embodiment of the invention; and

FIG. 7 is a schematic diagram illustrating an exemplary adjustment of the video frame en-coding rule with respect to the embodiment of FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

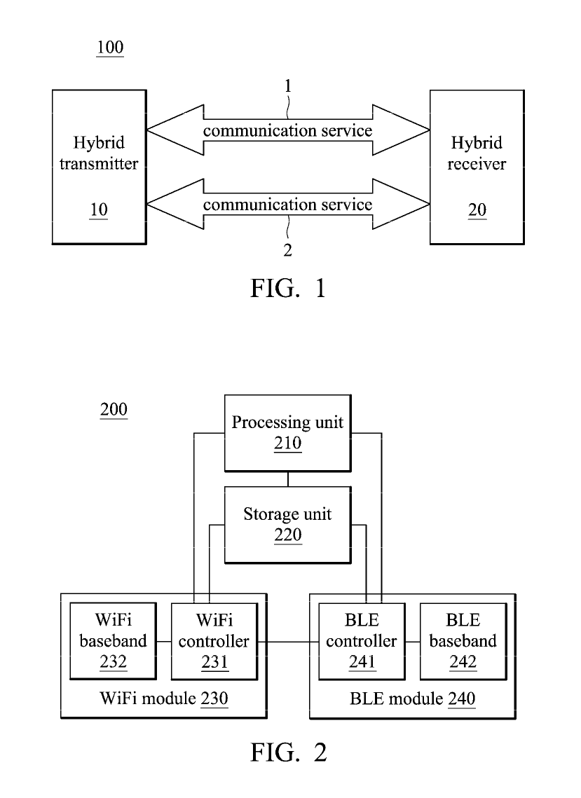

FIG. 1 is a block diagram of a wireless communication environment according to an embodiment of the invention. The wireless communication environment 100 comprises a hybrid transmitter 10 and a hybrid receiver 20, wherein each of the hybrid transmitter 10 and the hybrid receiver 20 supports at least two wireless technologies for providing two different communication services 1 and 2 therebetween. Particularly, the hybrid receiver 20 may report the reception status information of the communication service 1 to the hybrid transmitter 10 using the communication service 2, or report the reception status information of the communication service 2 to the hybrid transmitter 10 using the communication service 1, so that the hybrid transmitter 10 may adjust the configuration associated with the communication service 1 or 2 according to the reception status information.

In one embodiment, the two wireless technologies may be the WiFi technology and the Bluetooth Low Energy (BLE) technology, and the communication services 1 and 2 may be in compliance with the communication protocols of the WiFi technology and the BLE technology, respectively. For example, the hybrid transmitter 10 may be a smart phone supporting the WiFi technology and the BLE technology, and the hybrid receiver 20 may be a smart TV with WiFi and BLE capabilities or coupled with a communication dongle which provides WiFi communication services and BLE communication services. In another embodiment, the two wireless technologies may both be WiFi technologies but operating on different frequency bands (e.g. one on 2.4 GHz and the other on 5 GHz) or channels (e.g. one on channel 1 and the other on channel 11). In yet another embodiment, the two wireless technologies may be any wireless technologies other than the WiFi technology and the BLE technology, e.g., a wireless technology operating on the 60 GHz frequency band and the classic Bluetooth technology, and the invention is not limited thereto. It is to be understood that, both of the hybrid transmitter 10 and the hybrid receiver 20 have the transmission and reception functionalities (or may be both referred to as hybrid transceivers), and the words “transmitter” and “receiver” are only used to specify the states of operations with regard to a particular communication services performed therebetween.

FIG. 2 is a block diagram illustrating an exemplary system architecture for the hybrid transmitter 10 and the hybrid receiver 20 according to an embodiment of the invention. The system architecture 200 comprises a processing unit 210, a storage unit 220, a WiFi module 230, and a BLE module 240. The processing unit 210 may be a general-purpose processor, an application processor, or others. The storage unit 220 may be a volatile memory, e.g., Random Access Memory (RAM), or non-volatile memory, e.g., FLASH memory, or hardware, compact disc, or any combinations thereof, which is responsible for storing program code or instruction sets which are executable by the processing unit 210 for controlling the operations, e.g., activating/deactivating, or enabling/disabling, etc., of the WiFi module 230 and the BLE module 240. The WiFi module 230 comprises a WiFi controller 231 and a WiFi baseband 232, wherein the WiFi controller 231 is a control unit, such as a Digital Signaling Processor (DSP) or a dedicated/embedded Micro Control Unit (MCU), for controlling the WiFi baseband 232 to provide the functionality of WiFi communication services using the WiFi technology. The BLE module 240 comprises a BLE controller 241 and a BLE baseband 242, wherein the BLE controller 241 is a control unit, such as a DSP or a dedicated/embedded MCU, for controlling the BLE baseband 242 to provide the functionality of BLE communication services using the BLE technology. Particularly, in this embodiment, the WiFi controller 231 is coupled with the BLE controller 241 for communications necessary for carrying out the information feedback method in the present invention, which will be described in detail with respect to the following figures. In another embodiment, the WiFi controller 231 may not be coupled with the BLE controller 241, and the communications between them may be performed through the processing unit 210.

Although not shown, the system architecture 200 may comprise other functional units or components, such as a video encoder/decoder for processing video frame encoding/decoding, a display unit (e.g., a screen, panel, or touch panel, etc.) with display functionality, and/or input/output device (e.g., a keyboard, mouse, or touch pad, etc.), and the invention is not limited thereto.

It is to be understood that the WiFi module 230 and the BLE module 240 are merely illustrative embodiments of wireless communication modules, and other wireless technologies may be used instead of the WiFi technology and the BLE technology.

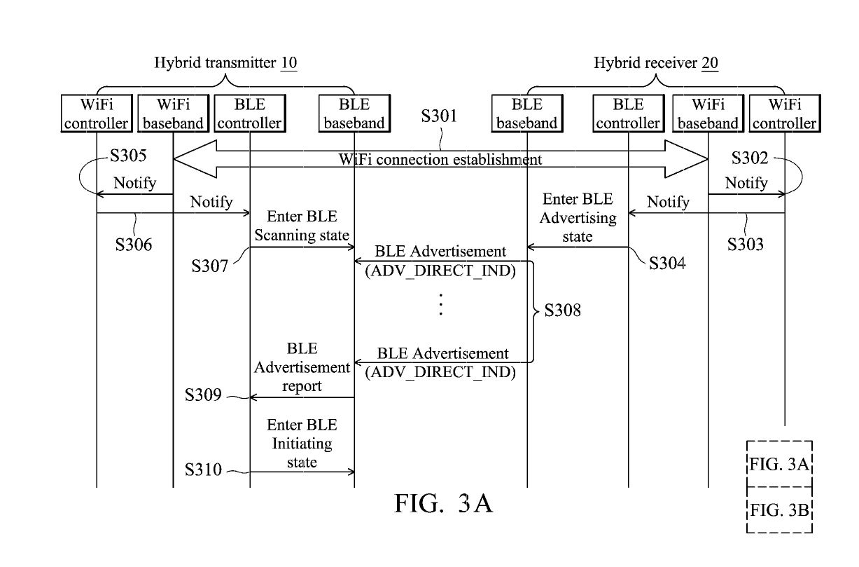

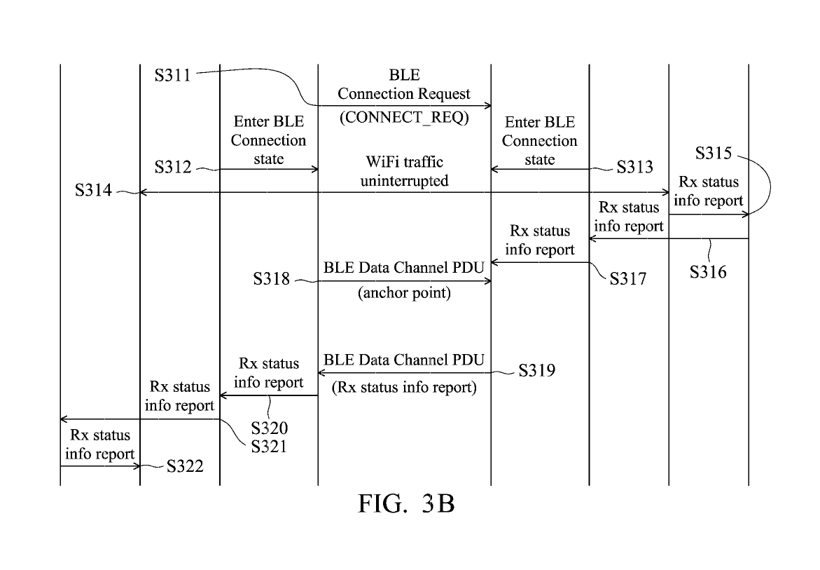

FIG. 3 is a message sequence chart illustrating the information feedback via the BLE Data Channel Connection with respect to the embodiment of FIG. 2. To begin, the WiFi baseband of the hybrid receiver 20 establishes a WiFi connection with the WiFi baseband of the hybrid transmitter 10 (step S301). Specifically, the WiFi connection establishment may refer to the Association process with an infrastructure Access Point (AP) (i.e., the hybrid transmitter 10), or joining a WiFi Direct Group as a client, or establishing a Tunneled Direct Link Setup (TDLS) direct link as a responder.

Next, in the hybrid receiver 20, the WiFi baseband notifies the WiFi controller about the completion of the WiFi connection establishment (step S302), and then the WiFi controller directly or indirectly notifies the BLE controller to turn on the BLE Advertising state (step S303). In response to the notification, the BLE controller requests the BLE baseband to enter the BLE Advertising state (step S304).

Meanwhile, in the hybrid transmitter 10, the WiFi baseband notifies the WiFi controller about the completion of the WiFi connection establishment (step S305), and then the WiFi controller notifies the BLE controller to turn on the BLE Scanning state (step S306). In response to the notification, the BLE controller requests the BLE baseband to enter the BLE Scanning state (step S307).

In one embodiment, during the connection establishment in step S301, a pre-defined Information Element (IE) may be embedded in certain WiFi frames (e.g., Probe Request/Response, Association Request/Response, P2P Invitation Request/Response, or TDLS Setup Request/Response, etc.) to trigger the hybrid receiver 20 and the hybrid transmitter 10 to enter the BLE Advertising state and the BLE Scanning state, respectively.

After entering the BLE Advertising state, the BLE baseband of the hybrid receiver 20 starts broadcasting directed connectable advertisements periodically (step S308, denoted as ADV_DIRECT_IND in FIG. 3). Optionally, the BLE advertisement packets can carry in their payloads additional instructions to the hybrid transmitter 10 for setting up the out-of-band feedback channel. Upon receiving a connectable advertisement from the hybrid receiver 20, the BLE baseband of the hybrid transmitter 10 reports the received advertisement to the BLE controller of the hybrid transmitter 10 (step S309). In response to the report of the received advertisement, the BLE controller requests the BLE baseband to enter the BLE Initiating state (step S310).

After entering the BLE Initiating state, the BLE baseband of the hybrid transmitter 10 may start to establish a BLE Data Channel Connection with the BLE baseband of the hybrid receiver 20. Specifically, the BLE baseband of the hybrid transmitter 10 transmits a BLE Connection Request to the BLE baseband of the hybrid receiver 20 (step S311). After that, the BLE Data Channel Connection may be construed as have being successfully established. In the hybrid transmitter 10, the BLE controller further requests the BLE baseband to enter the BLE Connection state (step S312). Meanwhile, in the hybrid receiver 20, the BLE controller requests the BLE baseband to enter the BLE Connection state after the BLE baseband receives the BLE Connection Request from the hybrid transmitter 10 (step S313). At this point, a BLE Data Channel Connection between the hybrid transmitter 10 and the hybrid receiver 20 is created, in which the hybrid transmitter 10 becomes a BLE Master and the hybrid receiver 20 becomes a BLE Slave.

Note that, the communications between the WiFi basebands of the hybrid transmitter 10 and the hybrid receiver 20 are not interrupted and may continue after the WiFi connection has been established (step S314). For the communications via the WiFi connection, the WiFi baseband of the hybrid receiver 20 generates the reception status information of the WiFi connection and then reports the reception status information to the WiFi controller of the hybrid receiver 20 (step S315). In the hybrid receiver 20, the WiFi controller forwards the reception status information to the BLE controller (step S316), and then the BLE controller further forwards the reception status information to the BLE baseband (step S317).

Specifically, the reception status information may comprise a singular or a combination of elements, such as Channel Quality Indicator (CQI), Signal-to-Noise Ratio (SNR), Packet Loss Rate (PLR), Packet Error Rate (PER), and receiving buffer status, etc.

Subsequently, the BLE baseband of the hybrid transmitter 10 transmits a BLE Data Channel Packet Data Unit (PDU) to the BLE baseband of the hybrid receiver 20 (step S318). Specifically, the BLE Data Channel PDU transmitted by the hybrid transmitter 10 becomes the anchor PDU of a BLE connection event (denoted as “anchor point” in FIG. 3) that repeats according to BLE connection event intervals. The anchor PDU may carry instructions for indicating what reception status information of the WiFi connection the hybrid transmitter 10 expects to receive from the BLE baseband of the hybrid receiver 20 in future BLE connection events. In one embodiment, an empty payload may be set for the anchor PDU if the hybrid transmitter 10 does not limit the information reported from the hybrid receiver 20.

In response to an anchor PDU, the BLE baseband of the hybrid receiver 20 reports the latest reception status information to the BLE baseband of the hybrid transmitter 10 with another BLE Data Channel PDU (step S319). In one embodiment, if the reception status information remains the same as the last feedback, an empty payload may be set in the BLE Data Channel PDU to indicate to the hybrid transmitter 10 that the reception status information has not been changed since last feedback.

When receiving the BLE Data Channel PDU comprising the reception status information, the BLE baseband of the hybrid transmitter 10 reports the reception status information to the BLE controller of the hybrid transmitter 10 (step S320). The BLE controller of the hybrid transmitter 10 further forwards the reception status information to the WiFi controller of the hybrid transmitter 10 (step S321), and then the WiFi controller forwards the reception status information to the WiFi baseband of the hybrid transmitter 10 (step S322), so that the configuration associated with the WiFi connection may be adjusted according to the reception status information.

Note that, steps S318 to S322 are performed periodically based on BLE connection event intervals determined by the hybrid transmitter 10 (the Master of BLE data channel connection) and communicated to the hybrid receiver 20 in BLE connection request (CONNECT_REQ as in step 311). More specifically, before initiating creation of the BLE data channel connection, the BLE baseband of the hybrid transmitter 10 may first determine a BLE connection event interval according to the Access Categories (AC) of the WiFi connection (e.g., AC_VO, AC_VI, AC_BE, or AC_BK) and the corresponding Quality of Service (QoS) requirements (e.g., bandwidth, delay budget, jitter budget, etc.). Each BLE connection event starts at the anchor point as denoted by step S318 and concludes at step S319. BLE connection event interval indicates a period of time between two consecutive BLE connection events. In other words, it defines how frequent the reception status information needs to be transmitted by the hybrid receiver 20. Also, the reception status information of the WiFi connection may be generated by the WiFi baseband of the hybrid receiver 20 for each received BLE Data Channel PDU from the hybrid transmitter 10.

For example, the BLE connection event interval may be set to a relatively large value, if the AC of the WiFi connection is AC_BE or AC_BK, or the corresponding QoS requirements indicate a high delay budget. Alternatively, the BLE connection event interval may be set to a relatively small value, if the AC of the WiFi connection is AC_VO or AC_VI, or the corresponding QoS requirements indicate a low delay budget.

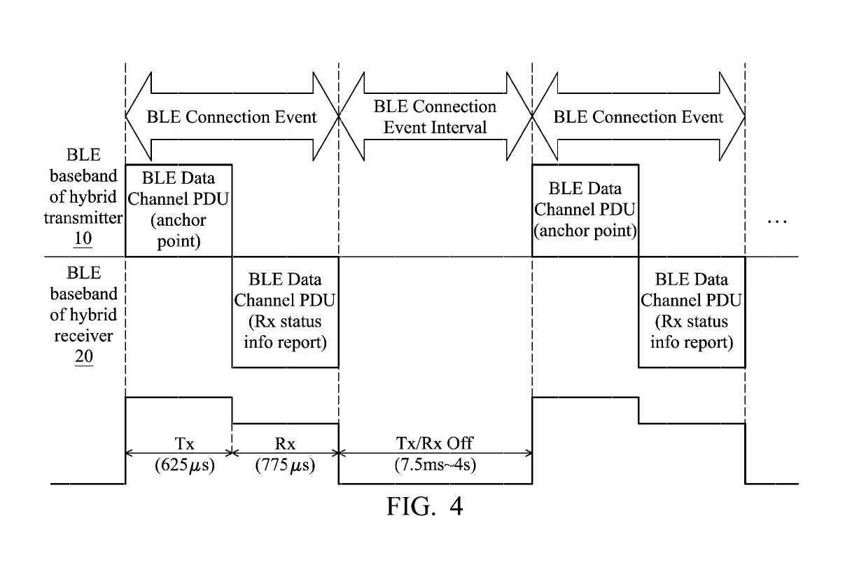

In addition, after the BLE Data Channel PDU comprising the reception status information is transmitted from the hybrid receiver 20 to the hybrid transmitter 10, the BLE basebands may be turned off until the next report, to save power both for the hybrid transmitter 10 and the hybrid receiver 20. FIG. 4 is a schematic diagram illustrating the operations of the BLE basebands in the BLE Connection state according to an embodiment of the invention. As shown in FIG. 4, the BLE basebands are turned off in each BLE connection event interval, and turned on again in each BLE connection event for requesting or reporting the reception status information, wherein the transmission and reception of the BLE Data Channel PDU take about 625 microseconds and 775 microseconds, respectively, and the BLE connection event interval is set to a value between 7.5 milliseconds and 4 seconds.

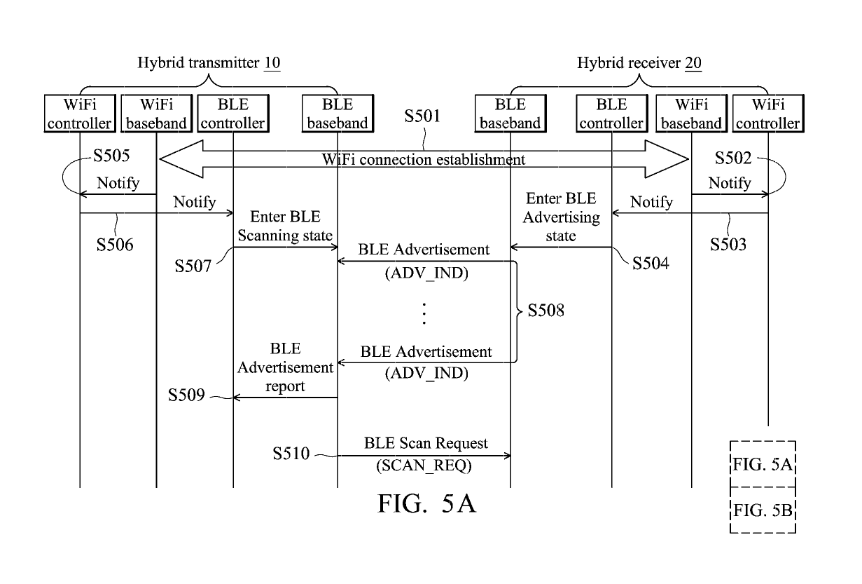

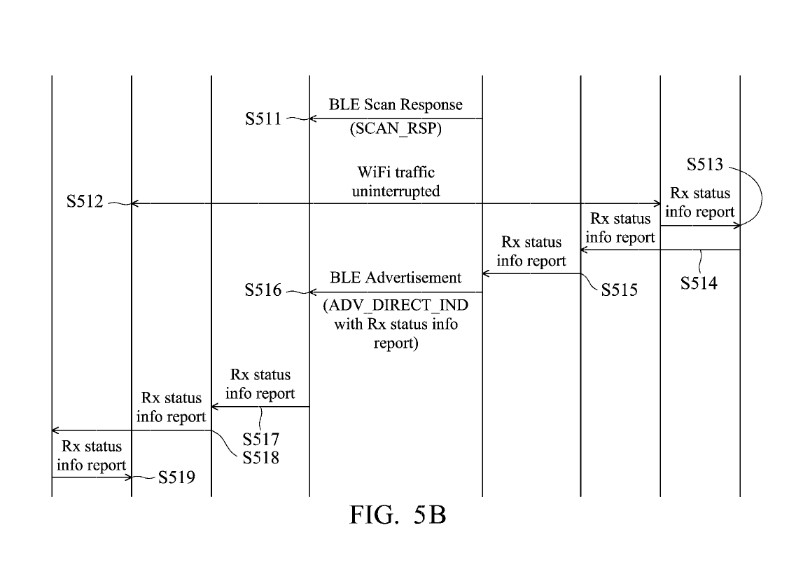

FIG. 5 is a message sequence chart illustrating the information feedback via the BLE Directed Advertisement with respect to the embodiment of FIG. 2. Similar to steps S301 to S309, a WiFi connection between the WiFi basebands of the hybrid transmitter 10 and the hybrid receiver 20 is established (step S501), and the notifications about the completion of the WiFi connection establishment is sent from the WiFi basebands to the BLE controllers via the WiFi controllers for both of the hybrid transmitter 10 and the hybrid receiver 20 (steps S502˜S503 and S505˜S506), wherein the BLE controllers further request the BLE basebands to enter the BLE Advertising state and BLE Scanning state (steps S504 and S507) for periodically broadcasting an advertisement or reporting the received advertisement, respectively (steps S508˜S509). Specifically, the payload of an advertisement packet comprises identification of the hybrid receiver 20 for whoever receives this advertisement to identify the hybrid receiver 20.

After reporting the received advertisement to the BLE controller, the BLE baseband of the hybrid transmitter 10 transmits a BLE Scan Request to the BLE baseband of the hybrid receiver 20 (step S510). The BLE Scan Request may comprise a SCAN_REQ PDU for triggering the information feedback from the hybrid receiver 20. In response to receiving the BLE Scan Request, the BLE baseband of the hybrid receiver 20 replies to the BLE baseband of the hybrid transmitter 10 with another BLE Scan Response comprising a SCAN_RSP PDU for indicating which BLE advertisement channel is used as the feedback channel (step S511). The BLE advertisement channels that can be used for feedback are channel 37, 38, or 39.

In one embodiment, when receiving the BLE Scan Response comprising the SCAN_RSP PDU, the BLE baseband of the hybrid transmitter 10 may tune into the feedback channel indicated by the SCAN_RSP PDU. In another embodiment, when receiving the BLE Scan Response comprising the SCAN_RSP PDU, the BLE baseband of the hybrid transmitter 10 may first forward the SCAN_RSP PDU to the BLE controller of the hybrid transmitter 10, and then the BLE controller may request the BLE baseband to tune into the feedback channel indicated by the SCAN_RSP PDU for scanning advertisements from the hybrid receiver 20.

Note that, the communications between the WiFi basebands of the hybrid transmitter 10 and the hybrid receiver 20 are not interrupted and may continue after the WiFi connection has been established (step S512). For the communications via the WiFi connection, the WiFi baseband of the hybrid receiver 20 generates the reception status information of the WiFi connection and then reports the reception status information to the WiFi controller of the hybrid receiver 20 (step S513). In the hybrid receiver 20, the WiFi controller forwards the reception status information to the BLE controller (step S514), and then the BLE controller further forwards the reception status information to the BLE baseband (step S515).

Subsequently, the BLE baseband of the hybrid receiver 20 broadcasts a BLE Advertisement (ADV_DIRECT_IND) directed to the hybrid transmitter 10 on the feedback channel for reporting the reception status information (step S516). When receiving the BLE Advertisement, the BLE baseband of the hybrid transmitter 10 derives the reception status information from the BLE Advertisement and reports to the BLE controller of the hybrid transmitter 10 (step S517). The BLE controller of the hybrid transmitter 10 further forwards the reception status information to the WiFi controller of the hybrid transmitter 10 (step S518), and then the WiFi controller forwards the reception status information to the WiFi baseband of the hybrid transmitter 10 (step S519), so that the configuration associated with the WiFi connection may be adjusted according to the reception status information.

Note that, steps S513 to S519 may be performed periodically. To further clarify, before step S510, the BLE baseband of the hybrid transmitter 10 may first determine a desired feedback interval according to the AC of the WiFi connection (e.g., AC_VO, AC_VI, AC_BE, or AC_BK) and the corresponding QoS requirements (e.g., bandwidth, delay budget, jitter budget, etc.), and then include the desired feedback interval in the BLE Scan Request in step S510, wherein the desired feedback interval indicates a period of time between two successive reports of the reception status information. If the BLE baseband of the receiver 20 is unable to adhere to the desired feedback interval, it may include a new feedback interval in the BLE Scan Response in step S511. Accordingly, the BLE basebands of the transmitter 10 and the receiver 20 use the desired feedback interval or the new feedback interval for scanning and broadcasting BLE advertisements, respectively. Particularly, after each scanning or broadcasting of a BLE advertisement, the BLE basebands may be turned off until the next report, to save power both for both of the hybrid transmitter 10 and the hybrid receiver 20.

When compared to the information feedback via the BLE Data Channel Connection, the information feedback via the BLE Directed Advertisement advantageously may avoid interference to/by the WiFi connection, since the frequency of the BLE advertisement channel does not always overlap with that of the WiFi channels. Also, for the information feedback via the BLE Directed Advertisement, the number of communicated messages between the hybrid transmitter 10 and the hybrid receiver 20 is less than that for the information feedback via the BLE Data Channel Connection, and thus, more power may be saved.

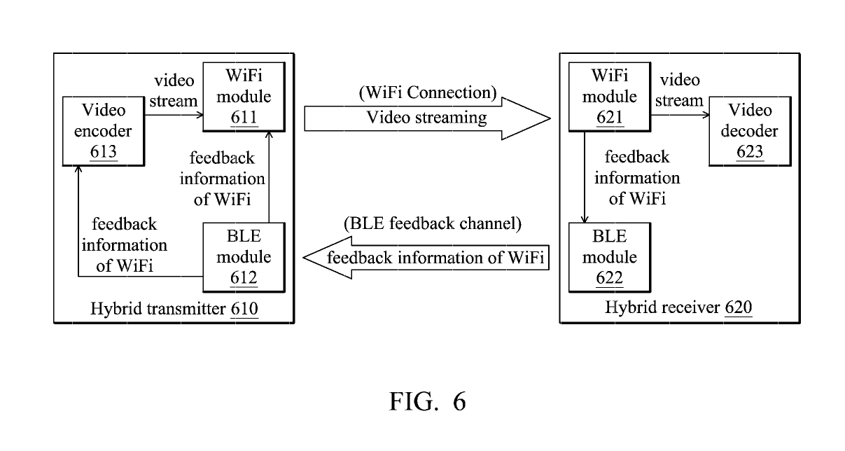

FIG. 6 is a block diagram illustrating a wireless communication environment for information feedback using the BLE technology during video streaming via a WiFi connection according to an embodiment of the invention. The hybrid transmitter 610 comprises a WiFi module 611, a BLE module 612, and a video encoder 613. The hybrid receiver 620 comprises a WiFi module 621, a BLE module 622, and a video decoder 623. The WiFi modules 611 and 621 are similar to the WiFi module 230, and the BLE modules 612 and 622 are similar to the BLE module 240, and thus, detailed description is omitted herein for brevity. The video encoder 613 and video decoder 623 may be a H.264 video encoder and a H.264 video decoder for compression and de-compression of video frames. As shown in FIG. 6, the hybrid transmitter 610 and the hybrid receiver 620 are connected via a WiFi connection established by the WiFi modules 611 and 621 for transmitting packetized Moving Picture Expert Group Transport Stream (MPEG-TS) with H.264 compression from the hybrid transmitter 610 to the hybrid receiver 620. The reception status information of the WiFi connection is dynamically reported from the hybrid receiver 620 to the hybrid transmitter 610 via the BLE feedback channel, wherein the BLE feedback channel may be the BLE Data Channel Connection as described in the embodiment of FIG. 3, or the BLE Advertisement Channel as described in the embodiment of FIG. 5. According to the reception status information, the video encoder 613 may make dynamic adjustments to the frame rate and/or bitrate of the encoded video stream.

The commonly used H.264 video encoder can produce three types of video frames, namely the I-frame, P-frame, and B-frame. The I-frame contains information of every pixel in the video frame and can be decoded by itself without referring to any other type of video frames. The I-frame is usually very large in data size (for instance, it's common for an I-frame to size up to 100 KB in HD 1080p video), and requires a very large bandwidth of the WiFi connection to transmit. In contrast to the I-frame, the P-frame can significantly reduce the bandwidth demand as it encodes only the delta changes from the immediate proceeding frame.

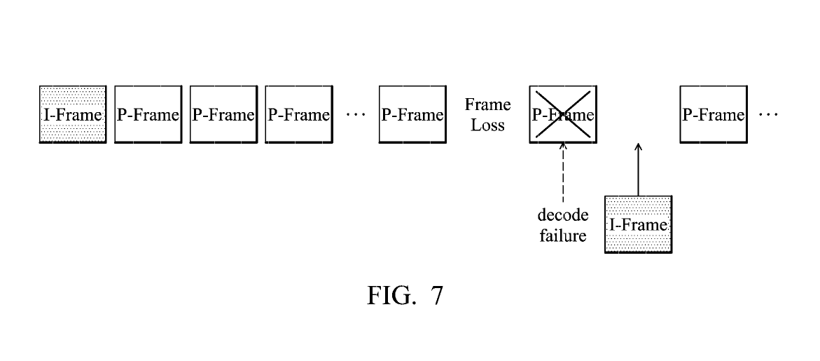

FIG. 7 is a schematic diagram illustrating an exemplary adjustment of the video frame en-coding rule with respect to the embodiment of FIG. 6. In FIG. 7, a typical H.264 video frame sequence consisting of I-frames and P-frames is depicted. The H.264 video frame sequence starts with an I-frame, followed by a series of P-frames. Given that each P-frame is dependent of its immediate proceeding frame, the video decoder 623 has great difficulty reconstructing a video frame if its proceeding frame is lost or corrupted. To remedy the situation, the video encoder 613 shall timely produce and transmit a new I-frame to the video decoder 623, so as to restart the decoding flow.

The ability for the video encoder 613 to timely produce a new I-frame relies heavily on timely feedback from the hybrid receiver 620 upon detection of a lost or corrupted frame. Conventionally, if the feedback is performed via the in-band WiFi connection, its arrival time is unpredictable and may take more than 160 milliseconds (i.e., about a 10-frame delay in the case of a 60 fps frame rate). Advantageously, the invention may achieve timely feedback to hasten the restart of the decoding flow and to eliminate the impact on the quality of the video streaming. Specifically, the out-of-band information feedback method of the invention may enable the hybrid receiver 620 to provide predictable and consistent feedback of the reception status information of the WiFi connection to the hybrid transmitter 610 within 10 milliseconds (i.e., less than one-frame delay in the case of a 60 fps frame rate) from the detection of a lost frame.

While the invention has been described by way of example and in terms of preferred embodiment, it is to be understood that the invention is not limited thereto. Those who are skilled in this technology can still make various alterations and modifications without departing from the scope and spirit of this invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A hybrid receiver, comprising:
a first wireless communication module establishing a first connection with a hybrid transmitter using a first wireless technology, and generating reception status information of the first connection; and
a second wireless communication module reporting the reception status information to the hybrid transmitter using a second wireless technology.

2. The hybrid receiver of claim 1, wherein the second wireless communication module further establishes a peer-to-peer connection with the hybrid transmitter using the second wireless technology, and the reception status information is reported to the hybrid transmitter via the peer-to-peer connection.

3. The hybrid receiver of claim 1, wherein the second wireless communication module further broadcasts an advertisement using the second wireless technology, and the reception status information is reported to the hybrid transmitter via the broadcasted advertisement.

4. The hybrid receiver of claim 1, wherein the reception status information comprises at least one of the following:
a Channel Quality Indicator (CQI);
a Received Signal Strength Indicator (RSSI) or Signal-to-Noise Ratio (SNR);
a Packet Loss Rate (PLR) or Packet Error Rate (PER); and
a receiving buffer status.

5. The hybrid receiver of claim 1, wherein the first wireless technology is a Wireless Fidelity (WiFi) technology, and the second wireless technology is a Bluetooth Low Energy (BLE) technology.

6. An information feedback method for a hybrid receiver supporting a first wireless technology and a second wireless technology, comprising:
establishing a first connection with a hybrid transmitter using the first wireless technology;
generating reception status information of the first connection; and
reporting the reception status information to the hybrid transmitter using the second wireless technology.

7. The information feedback method of claim 6, further comprising establishing a second connection with the hybrid transmitter using the peer-to-peer wireless technology, wherein the reception status information is reported to the hybrid transmitter via the peer-to-peer connection.

8. The information feedback method of claim 6, further comprising broadcasting an advertisement using the second wireless technology, wherein the reception status information is reported to the hybrid transmitter via the broadcasted advertisement.

9. The information feedback method of claim 6, wherein the reception status information comprises at least one of the following:
a Channel Quality Indicator (CQI);
a Received Signal Strength Indicator (RSSI) or Signal-to-Noise Ratio (SNR);
a Packet Loss Rate (PLR) or Packet Error Rate (PER); and
a receiving buffer status.

10. The information feedback method of claim 6, wherein the first wireless technology is a Wireless Fidelity (WiFi) technology, and the second wireless technology is a Bluetooth Low Energy (BLE) technology.

11. A hybrid transmitter, comprising:
a first wireless communication module establishing a first connection with a hybrid receiver using a first wireless technology; and
a second wireless communication module receiving reception status information of the first connection from the hybrid receiver using a second wireless technology, so that the first wireless communication module dynamically adjusts at least one configuration associated with the first connection according to the reception status information.

12. The hybrid transmitter of claim 11, wherein the second wireless communication module further establishes a peer-to-peer connection with the hybrid receiver using the second wireless technology, and the reception status information is received from the hybrid receiver via the peer-to-peer connection.

13. The hybrid transmitter of claim 11, wherein the second wireless communication module further receives an advertisement broadcasted by the hybrid receiver using the second wireless technology, and the reception status information is received from the hybrid receiver via the broadcasted advertisement.

14. The hybrid transmitter of claim 11, wherein the reception status information comprises at least one of the following:
a Channel Quality Indicator (CQI);
a Received Signal Strength Indicator (RSSI) or Signal-to-Noise Ratio (SNR);
a Packet Loss Rate (PLR) or Packet Error Rate (PER); and
a receiving buffer status.

15. The hybrid transmitter of claim 11, wherein the configuration comprises at least one of the following:
a Modulation and Coding Scheme (MCS);
a transmission power;
a transmission data buffer;
a transmission channel or band; and
a video stream frame rate or bitrate.

16. The hybrid transmitter of claim 11, wherein the first wireless technology is a Wireless Fidelity (WiFi) technology, and the second wireless technology is a Bluetooth Low Energy (BLE) technology.

17. An information feedback method for a hybrid transmitter supporting a first wireless technology and a second wireless technology, comprising:
establishing a first connection with a hybrid receiver using the first wireless technology;
receiving reception status information of the first connection from the hybrid receiver using the second wireless technology; and
adjusting at least one configuration associated with the first connection according to the reception status information.

18. The information feedback method of claim 17, further comprising establishing a peer-to-peer connection with the hybrid receiver using the second wireless technology, wherein the reception status information is received from the hybrid receiver via the peer-to-peer connection.

19. The information feedback method of claim 17, further comprising receiving an advertisement broadcasted by the hybrid receiver using the second wireless technology, wherein the reception status information is received from the hybrid receiver via the broadcasted advertisement.

20. The information feedback method of claim 17, wherein the reception status information comprises at least one of the following:
a Channel Quality Indicator (CQI);
a Received Signal Strength Indicator (RSSI) or Signal-to-Noise Ratio (SNR);
a Packet Loss Rate (PLR) or Packet Error Rate (PER); and
a receiving buffer status.

21. The information feedback method of claim 17, wherein the configuration comprises at least one of the following:
a Modulation and Coding Scheme (MCS);
a transmission power;
a transmission data buffer;
a transmission channel or band; and
a video stream frame rate or bitrate.

22. The information feedback method of claim 17, wherein the first wireless technology is a Wireless Fidelity (WiFi) technology, and the second wireless technology is a Bluetooth Low Energy (BLE) technology.
